(19) United States
(12) Patent Application Publication
(10) Pub. No.: US 2015/0026895 A1
(43) Pub. Date: Jan. 29, 2015

(54) ANTI-BEDSORE MATTRESS COMPRISING AIR POCKETS

(71) Applicants: Franciscus Jozef Henri GEELEN, Beek (NL); Irene Clementine Mirjam BEST, Beek (NL)

(72) Inventors: Franciscus Jozef Henri GEELEN, Beek (NL); Irene Clementine Mirjam BEST, Beek (NL)

(73) Assignee: DECUPRE B.V., Beek (NL)

(21) Appl. No.: 14/340,917

(22) Filed: Jul. 25, 2014

(30) Foreign Application Priority Data
Jul. 25, 2013 (NL) 2011216

(51) Int. Cl. A61G 7/057; A47C 27/08; A47C 27/00

(52) U.S. Cl. CPC A61G 7/05769; A47C 27/005; A47C 27/088
USPC 5/699

(57) ABSTRACT

A mattress comprises a mattress body (2, 3, 14) made of a resilient material, such as foam rubber, and a covering (12) which is fixed to the mattress body (2, 3, 14), such as a moisture-impermeable covering. The mattress body has at least two adjoining mattress body sections (2, 3, 14) which have mutually facing boundary surfaces (4, 5; 6, 7), to which boundary surfaces (4, 5; 6, 7) a covering (12) is likewise fixedly fitted. The covering (12) of at least one (14) of the mattress body sections has a substantially airtight casing (15) which is connected to an air connection (17).

The invention relates to a mattress, comprising a mattress body made of a resilient material, such as foam rubber, and a covering which is fixed to the mattress body, such as a moisture-impermeable covering, which mattress body comprises at least two adjoining mattress body sections, which covering comprises at least two closed covering sections and each mattress body section is completely enclosed in an associated closed covering section, which mattress body sections have mutually facing boundary surfaces, to which boundary surfaces a covering is likewise fixedly fitted.

Such a mattress is known from EP-A-1719436, and is used in particular in the care sector and in the medical sector. The mattress body of this known mattress usually consists of a foam material, such as a foam rubber, while the covering often consists of polyurethane. The foam rubber mattress body offers comfortable support, while the covering serves to prevent bodily fluids from penetrating into the foam rubber mattress body.

Furthermore, mattresses are known in which a separate cover is fitted on the mattress body. An example of such a mattress with a separate cover is the subject of FR-A-2953387. Covers are known which consist of a textile material which is covered with the moisture-impermeable polyurethane layer. The drawback of these known mattresses is that fitting the separate cover is laborious. This is all the more pressing as people in the care sector are under great time pressure. In addition, such a separate cover is not able to protect the mattress body completely, as the underside of the mattress body usually remains exposed. As a result thereof, the mattress body can become soiled, making it unusable.

It is furthermore known to make these mattresses modular. This means that certain parts of the mattress bodies can be removed, which is important in particular when trying to prevent bedsores. Thus, it is known, for example, to make the mattress body section at the foot end detachable in order to thus relieve the pressure on the heels of the person in question. After the respective mattress body section has been removed, the protective cover has to be fitted back on. However, this means that the cover also extends across the open mattress body section, so that the heels of the person will touch the cover again. Even though the resulting pressure is low, this will lead to bedsores once again. Nevertheless, the cover cannot be omitted, since the mattress would then become soiled.

A further drawback of these known modular mattresses is the fact that the removed parts are unprotected and can therefore become soiled. In particular, soiling by bacteria is highly undesirable. This may nevertheless occur, for example when the removed part is treated carelessly and is temporarily stored, for example in a cupboard. When the part that has become soiled is then placed back in the mattress again, the risk of infection for the subsequent patients may be quite high, even after the protective cover has been replaced.

The mattress known from EP-A-1719437 does not have these drawbacks as its mattress body comprises mattress body sections whose mutually facing boundary surfaces are provided with a fixed covering. With this known mattress, measures against bedsores are possible due to the fact that the mattress body section where bedsores might occur can be removed. In this case, it may for example be the mattress body section near the heels, but it is also possible to make other mattress body sections detachable. Thus, it would, for example, also be possible to remove the mattress body section situated near the coccyx of the person if bedsores were to occur in said location. As the mattress body sections are completely covered with the fixed covering, it is not necessary to fit a separate cover, not even when a certain mattress body section has been removed. After all, the surfaces which are exposed after a certain mattress section has been removed are completely covered. As a result thereof, the inside of the mattress body section cannot become soiled. The climate remains completely free from bacteria, ensuring optimum protection of the patients.

The body part which is situated at the location of the clear space which has been created by removing the respective mattress body section now does not make any contact with the mattress or a cover. This is very comfortable for the patient and also has a beneficial effect on healing or preventing bedsores. There is no pressure at all on the respective body part, except for the air pressure. The importance of preventing bedsores cannot be underestimated. This is, inter alia, evidenced by the fact that, until now, healing or preventing bedsores has been associated with very high costs, which costs can be reduced significantly by the mattress according to the invention.

Although this known mattress is satisfactory, it can be improved upon further, in the sense that the removal of mattress sections (or the fitting of mattress sections) for alleviating bedsores could be (partly) omitted. This object is achieved by the fact that the covering section of at least one of the mattress body sections comprises a substantially airtight casing which is connected to an air connection.

According to the invention, this still has the advantage, on the one hand, that the various mattress sections, which after all consist of a mattress body section covered with the airtight covering section in the form of a casing, are well protected against soiling and the like. On the other hand, it is not always necessary to remove this mattress section, but it suffices to reduce the internal pressure thereof in order to prevent bedsores in that location. Such a mattress body section with an airtight casing may optionally also be removed in its entirety, if this is more beneficial in preventing said problems.

The mattress body section with airtight casing may be configured in any possible way and in any possible shape. In particular, this mattress body section with airtight casing may be elongate and have a non-circular cross section. In this case, the mattress body section may have a non-circular cross section and be positioned in such a way that the direction in which the dimension of said cross section is relatively small is at right angles to the supporting surface of the mattress body.

In the pressureless or virtually pressureless state, such a mattress section has a relatively flat shape which may bring comfort in the case of bedsores. In the state in which air is supplied to the airtight casing, such a mattress section has a relatively high shape, i.e. a shape which approximates a circular rather than an oval or elliptical shape and thus provides better support.

One such embodiment in particular offers a good combination of support and relief if several mattress body sections, each having an airtight casing, are positioned adjacent to each other and preferably extend in the transverse direction of the mattress. If these mattress body sections are then supplied with air in turns, in which case the air pressure is increased or lowered in turns, the support for the human body can periodically be raised or lowered, respectively.

To this end, in each case a pressure-regulating valve and an air supply may be connected to the air connection of each mattress body section with airtight casing in order to vary the air pressure in the respective casings. Preferably, the foam material of the mattress body sections with airtight casing is porous and permeable to air in this case.

With the mattress known from EP-A-1719436, fastening means are provided to fasten the mattress sections to one another. This may also be the case with the mattress sections with airtight casing. These fastening means can be configured in a variety of different ways. Preferably, they are incorporated in the various mattress sections.

The fastening means may comprise mating profile shapes, so that the mattress sections can be pushed together or pushed apart in a simple manner. These mating profile shapes may, for example, comprise an undercut cavity in one of the mattress sections, in which case the other mattress section has a correspondingly shaped ridge which can be pushed into the undercut cavity.

Thus, the profile shapes may be, for example, in the shape of a dovetail, viewed in cross section. However, other profile shapes are also possible, such as profile sections which are, for example, circular in cross section.

However, according to an alternative embodiment, it is also possible to omit the fastening means, so that the mattress body sections lie loosely on top of one another or in each other, preferably while including a non-slip layer.

The mattress comprises an outer surface which is free on all sides, wherein the outer surface which is free on all sides is only formed by all the outwardly turned surfaces of the covering sections of all mattress body sections. This means that the mattress does not have a separate cover which has to be removed or fitted after cleaning. This is possible due to the fact that all covering sections of all mattress body sections themselves are already sealed and impermeable to bodily fluids, and they each completely surround the entire associated mattress body section.

The term “mattress” is understood to refer not only to bed mattresses, but also to mattresses in the form of pillows which may be used as a seat or backrest of a chair and the like.

The invention will be explained in more detail below by means of an exemplary embodiment which is illustrated in the figures, in which:

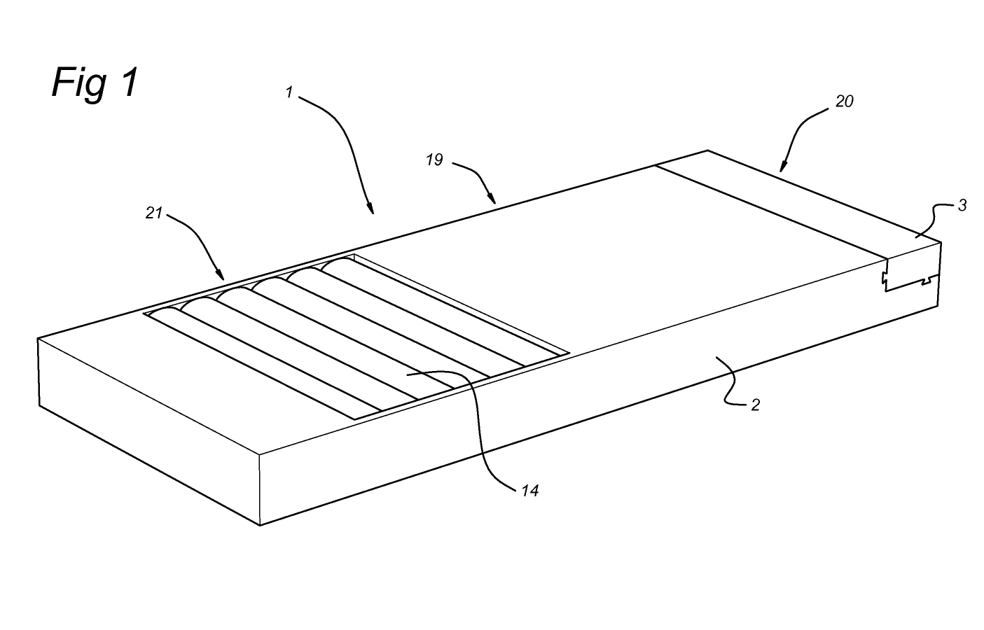

FIG. 1 shows the mattress according to the invention.

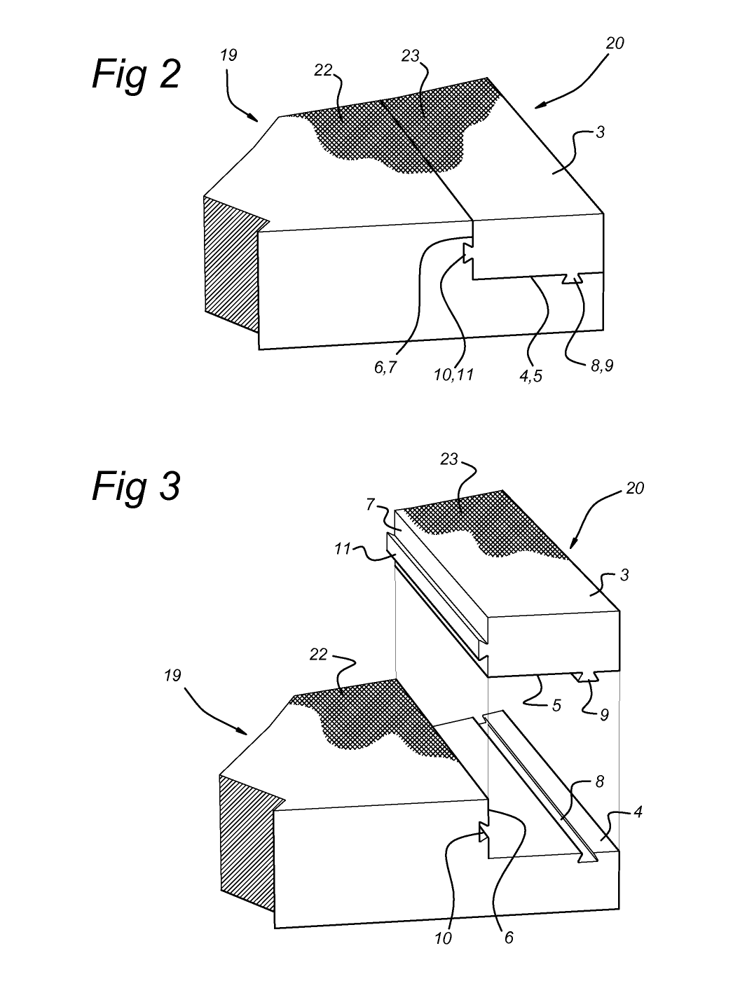

FIG. 2 shows the mattress according to FIG. 1 with the heel part removed.

FIG. 3 shows the removed heel part.

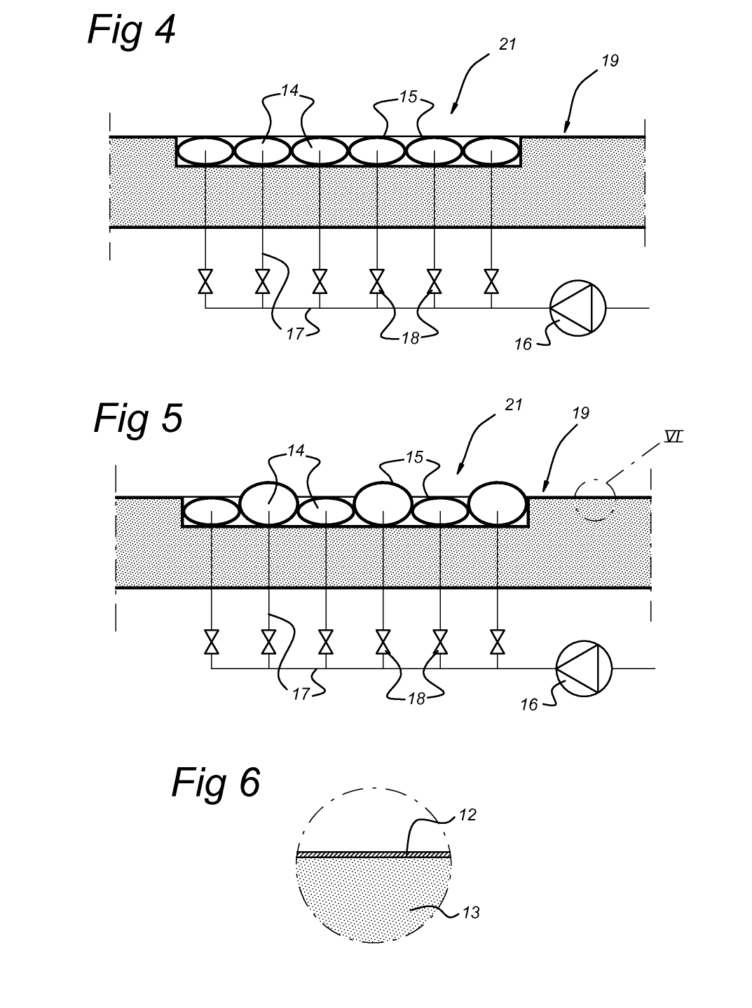

FIG. 4 shows the mattress with inflatable mattress sections.

FIG. 5 shows the mattress according to FIG. 4 with a few inflated mattress sections.

FIG. 6 shows a detail with the covering.

The mattress denoted overall by reference numeral 1 in FIG. 1 comprises the mattress section 19 consisting of the mattress body section 2 (illustrated in FIG. 2) with covering 22, the mattress section 20 from the mattress body section 3 in the form of a heel part with covering 23 and a series of mattress sections 21, each comprising a mattress body section 14 and an airtight casing 15. In the longitudinal sections from FIGS. 4 and 5, these mattress body sections 14 with airtight casing 15, also referred to overall as mattress sections 21, are also illustrated. The casing 15 may consist of a polyurethane.

The mattress sections 21 are each connected to an air line 17 which is connected to the pump 16 via a valve 18. As is illustrated in FIG. 4, the mattress sections 21 have an oval or elliptical cross section in the rest position which is the result of the shape of the cross section of the mattress body section 14. However, as soon as air is supplied to these mattress sections 21, the shape will tend to assume a circular cross section, as is illustrated in FIG. 5, in which the second, fourth and sixth mattress section, viewed from the left, have been inflated. It is possible to alternately control all mattress sections 21 in such a way that the human body can be supported or released at alternating locations, in this case at the location of the upper body.

As is illustrated in FIGS. 2 and 3, the mattress section 19 and the mattress section 20 fit tightly. They have horizontal mutually facing boundary surfaces 4, 5, and vertical mutually facing boundary surfaces 6, 7. An undercut groove 8 is provided in the horizontal boundary surface 4 of the mattress section 19. A correspondingly shaped ridge 9 is provided on the horizontal boundary surface 5 of the mattress section 20.

As is illustrated in FIGS. 1 and 2, this ridge 9 and groove 8 can be brought into strong engagement in order to fix the mattress section 20 with respect to the mattress section 19. Similarly, the vertical boundary surface 6 of the mattress section 19 has a groove 10, while the vertical boundary surface 7 of the mattress section 20 has a ridge 11. This ridge 11 and groove 10 also fit tightly together, as is illustrated in FIG. 1, as a result of which a further strong fastening between the mattress body section 2 and the heel part 3 is ensured.

Both the mattress body section 2 of the mattress section 19 and the heel part 3 of the mattress section 20 are completely covered with the polyurethane covering 22, 23. This polyurethane covering 22, 23 is fixed to the foam material of both the mattress body section 2 and of the heel part 3. The polyurethane covering 22, 23 offers good protection against, for example, moisture, blood and the like penetrating into the foam material.

Although the mattress body section 2 and the heel part 3 are fastened to each other by mating profile sections 4, 5 and 10, 11 in the illustrated exemplary embodiment, other fastening means are also conceivable. By way of example, engaging studs, Velcro strips and the like are mentioned.

It is also possible to choose a different material for the covering 15, 22, 23. The covering has to fulfil the requirement that bodily fluids, blood and the like are repelled, so that they do not penetrate into the foam body 13.

### LIST OF REFERENCE NUMERALS

1. Mattress
2. Mattress body section
3. Mattress body section (heel part)
4.-7. Boundary surface
8. Undercut groove
9. Ridge
10. Undercut groove
11. Ridge
14. Mattress body section (inflatable)
15. Airtight casing
16. Pump
17. Air line
18. Valve
19. Mattress section from mattress body section 2 and covering section 22
20. Mattress section from mattress body section 3 and covering section 23
21. Mattress section from mattress body section 14 and casing 15
22. Covering section
23. Covering section

1. Mattress (1), comprising a mattress body made of a resilient material, such as foam rubber, and a covering which is fixed to the mattress body, such as a moisture-impermeable covering, which mattress body comprises at least two adjoining mattress body sections (2, 3, 14), which covering comprises at least two closed covering sections (15, 22, 23) and each mattress body section (2, 3, 14) is completely enclosed in an associated closed covering section (15, 22, 23), which mattress body sections (2, 3, 14) have mutually facing boundary surfaces (4, 5; 6, 7), characterized in that the covering section of at least one (14) of the mattress body sections comprises a substantially airtight casing (15) which is connected to an air connection (17).

2. Mattress (1) according to claim 1, wherein the at least one mattress body section (14) with airtight casing (15) is elongate and has a non-circular cross section, such as a substantially oval or elliptical cross section, and that at least one mattress body section (14) with non-circular cross section is positioned such that the direction in which the dimension of said cross section is relatively small is at right angles to the supporting surface of the mattress body (2, 3, 14).

3. Mattress according to claim 1, wherein several mattress body sections (14), each having an airtight casing (15), are positioned adjacent to each other, preferably in the transverse direction of the mattress body (2, 3, 14).

4. Mattress according to claim 1, wherein a pressure-regulating valve (18) and an air supply (16) are connected to the air connection (17) in order to vary the air pressure in the casing (15).

5. Mattress according to claim 1, wherein the foam material of the at least one mattress body section (14) with airtight casing (15) is porous and permeable to air.

6. Mattress according to claim 1, wherein the covering (12) comprises polyurethane.

7. Mattress according to claim 1, wherein fastening means (8, 9; 10, 11) are provided to fasten the mattress sections (19-21) to each other, such as fastening means (8, 9; 10, 11) which are incorporated in the mattress sections (2, 3, 14).

8. Mattress according to claim 7, wherein the fastening means (8, 9; 10, 11) comprise mating profile shapes, such as an undercut cavity (8; 10) in one of the mattress sections (19), and a correspondingly shaped ridge (9, 11) on the other mattress section (20).

9. Mattress according to claim 1, wherein the mattress body sections (2, 3, 14) lie loosely on top of one another or in each other, preferably while including a non-slip layer.

10. Mattress according to claim 1, wherein one of the mattress body sections (3) with covering (12) is situated on the upper side of the foot end (heel part).

11. Mattress according to claim 1, wherein all mattress body sections (2, 3, 14) are completely covered with the fixed covering or the casing (12, 15), respectively.

12. Mattress according to claim 1, wherein at least one mattress section (21), whose covering section comprises a substantially airtight casing (15) which is connected to an air connection (17), is detachable with respect to a further mattress section (19).

13. Mattress according to claim 1, wherein, in contrast to a mattress section (21) whose covering section comprises a substantially airtight casing (15) which is connected to an air connection (17), at least mattress section (20) is detachable with respect to a further mattress section (19).

14. Mattress according to claim 1, comprising an outer surface which is free on all sides, wherein the outer surface which is free on all sides is only formed by all the outwardly turned surfaces of the covering sections (15, 22, 23) of all mattress body sections (2, 3, 14).

15. Mattress according to claim 1, wherein the covering (12) is also fixedly fitted to the mutually facing boundary surfaces (4, 5; 6, 7) of the mattress body sections (2, 3, 14).

16. Mattress according to claim 2, wherein several mattress body sections (14), each having an airtight casing (15), are positioned adjacent to each other, preferably in the transverse direction of the mattress body (2, 3, 14).

17. Mattress according to claim 2, wherein a pressure-regulating valve (18) and an air supply (16) are connected to the air connection (17) in order to vary the air pressure in the casing (15).
